(19) United States
(12) Patent Application Publication
(10) Pub. No.: US 2025/0177247 A1
(43) Pub. Date: Jun. 5, 2025

(54) SELF-POWERED ELECTROACUPUNCTURE NEEDLES AND APPLICATIONS THEREOF

(71) Applicant: City University of Hong Kong, Hong Kong (HK)

(72) Inventors: Jinlian HU, Hong Kong (HK); Saira IQBAL, Hong Kong (HK)

(21) Appl. No.: 18/919,442

(22) Filed: Oct. 18, 2024

Related U.S. Application Data
(60) Provisional application No. 63/604,200, filed on Nov. 30, 2023.

(51) Int. Cl. A61H 39/00; A61H 39/08

(52) U.S. Cl. CPC A61H 39/002; A61H 39/08

(57) ABSTRACT

A self-powered electroacupuncture needle is provided, including a conductive needle and a triboelectric nanogenerator (TENG) coating on at least a portion of the needle. The TENG includes a triboelectric layer configured to accept electrons and an electron-providing layer configured to donate electrons. The TENG is positioned with the triboelectric layer in contact with the needle, such that when compressed, electron transfer occurs between the layers, generating a therapeutic alternating current with a frequency range of 0.1-10 Hz in the needle, facilitating the delivery of electroacupuncture treatment.

### CROSS-REFERENCE TO RELATED APPLICATIONS

The present application claims priority from U.S. provisional patent application Ser. No. 63/604,200 filed Nov. 30, 2023, and the disclosure of which is incorporated herein by reference in its entirety.

### FIELD OF THE INVENTION

The present invention generally relates to the traditional Chinese medicine field. More specifically the present invention relates to a self-powered electroacupuncture system.

### BACKGROUND OF THE INVENTION

Acupuncture, a central practice in traditional Chinese medicine (TCM), has been utilized for over 2500 years. This therapeutic technique involves the insertion of thin needles into specific locations on the body known as acupuncture points (APs). Extensive research has demonstrated that acupuncture offers significant therapeutic benefits for a variety of neurological conditions, including stroke, spinal cord injury (SCI), peripheral nerve injury, and neurodegenerative diseases. Electroacupuncture (EA) is a specialized form of acupuncture in which electric stimulation is applied to the needles, either for anesthetic or analgesic purposes. This method has been shown to promote tissue repair in various types of tissues, including bone, where it enhances callus formation and bone mineralization. Furthermore, electroacupuncture has demonstrated efficacy in healing chronic wounds that are resistant to conventional treatments and has been widely employed in China for neurological conditions and the regulation of transepithelial potential difference (TEPD).

Electroacupuncture's effectiveness in wound healing is mediated through mechanisms involving the immunoinflammatory response, cell proliferation, and tissue remodeling. It has also shown promise in treating conditions such as Alzheimer's disease and Parkinson's disease. In addition to increasing cutaneous blood flow, electroacupuncture has been associated with reductions in the expression and/or activation of pro-nerve growth factor, tumor necrosis factor α, interleukin 1β, interleukin 6, nitric oxide synthase, cyclooxygenase 2, and matrix metalloproteinase 9.

Clinical trials have increasingly validated the therapeutic efficacy of electroacupuncture in a range of conditions, including pain management, hypertension, depression, and neuroregeneration. For example, Salazar, T. E. et al. discovered that electroacupuncture stimulation of the nervous system releases reparative mesenchymal stem cells (MSCs) into the peripheral blood, thereby promoting tissue repair and reducing injury-induced pain. Li et al. found that electroacupuncture stimulation of the Zusanli (ST36) and Shangjuxu (ST37) APs significantly increased enkephalin precursor levels in the ventrolateral region of the rostral medulla in rats, suggesting that EA can effectively lower blood pressure. Similarly, Liu et al. demonstrated that low-intensity EA stimulation of ST36 activates the parasympathetic nervous system, signaling the vagus nerve to communicate with the adrenal glands to suppress severe inflammation, including infections and autoimmune diseases. The World Health Organization (WHO) recognizes acupuncture as an effective treatment modality for 28 diseases, symptoms, or conditions and has identified approximately 360 acupuncture points. Recent studies have also shown that acupuncture can increase pain thresholds and reduce anxiety, highlighting the potential of TENG sensors to monitor and enhance the efficacy of acupuncture treatments, thereby contributing to advancements in healthcare technology.

Despite the widespread benefits of electroacupuncture, there are still challenges to be addressed, such as the need to miniaturize the power generation equipment and develop self-powered electroacupuncture devices. Current limitations, including low output current and concerns about device reliability, underscore the need for innovation in this area. The present invention seeks to address these challenges, offering solutions that advance the practical application and effectiveness of electroacupuncture therapy.

### SUMMARY OF THE INVENTION

It is an objective of the present invention to provide an apparatus, or system to solve the aforementioned technical problems.

In accordance with a first aspect of the present invention, a self-powered electroacupuncture needle is provided. The needle includes a conductive needle; and a triboelectric nanogenerator (TENG) coating on at least a portion of the conductive needle. The TENG includes a triboelectric layer configured to accept electrons and an electron-providing layer configured to donate electrons.

In accordance with one embodiment of the present invention, the TENG is positioned on the conductive needle with the triboelectric layer in contact with the needle such that electron transfer is induced between the triboelectric layer and the electron-providing layer when these layers are compressed, generating a therapeutic alternating current at a frequency range of 0.1-10 Hz in the needle for delivering electroacupuncture treatment.

In accordance with another embodiment of the present invention, a head of the conductive needle is a coiled head.

In accordance with one embodiment of the present invention, the TENG further includes an insulating layer and a protective layer.

In accordance with one embodiment of the present invention, the insulating layer is positioned between the triboelectric layer and the electron-providing layer and the protective layer is positioned on the electron-providing layer In accordance with one embodiment of the present invention, the triboelectric layer is a flexible material doped with 1-5% of conductive nanoparticles, wherein the conductive nanoparticles form a conductive mesh within the flexible material. In a preferable embodiment, the triboelectric layer is a flexible material doped with 2% of conductive nanoparticles

In accordance with one embodiment of the present invention, the flexible material is selected from polydimethylsiloxane or polyimide.

In accordance with one embodiment of the present invention, the conductive nanoparticles are selected from multiwalled carbon nanotubes, graphene, silver nanowires, or carbon black.

In accordance with one embodiment of the present invention, the triboelectric layer has a porous microstructure with a porosity of ranging from 5-50%, configured for increasing the surface area for electron exchange.

In accordance with one embodiment of the present invention, the electron-providing layer is composed of a conductive metal selected from one or more of Cu, Ag, or Au.

In accordance with one embodiment of the present invention, the conduct needle includes a material selected from stainless-steel, gold plaited stainless steel, gold, silver, or a combination thereof.

In accordance with a second aspect of the present invention, a self-powered electroacupuncture system is introduced. Particularly, the system includes:
one or more of the aforementioned self-powered electroacupuncture needles that includes a conductive needle and a TENG, configured to generate a current for conducting electroacupuncture;
a power management unit configured to regulate and store electrical energy generated by the TENG;
a control unit configured to adjust stimulation parameters of the needle;
a display mechanism for providing feedback on treatment status an external force supplier configured to supply an external force to the TENG; and
a sensor unit for monitoring treatment parameters.

In accordance with one embodiment of the present invention, the system further includes a data storage and transfer module configured to record treatment data and the stimulation parameters.

In accordance with one embodiment of the present invention, the system further includes an external power source.

In accordance with one embodiment of the present invention, the system further includes a communication interface configured to allow the system to communicate with other medical devices or a central computer system for integrated patient care.

In accordance with one embodiment of the present invention, the external force supplier includes a manual force applied by a healthcare provider. It is worth noting that the manual force, including but not limited to pinching, rotating, lifting-and-thrusting, or pressing the needle, compresses the TENG to generate the electrical current necessary for electroacupuncture treatment.

### BRIEF DESCRIPTION OF THE DRAWINGS

Embodiments of the invention are described in more details hereinafter with reference to the drawings, in which:

FIGS. 1A-1F depict the fabrication process and principle of contact separation TENG, in which FIG. 1A depicts the preparation process of TENG manufacture, FIG. 1B demonstrates the three samples of 2-layer sensors, including PI/Cu, PDMS/Cu, MWCNTs@PDMS/Cu TENG, FIG. 1C show scanning electron microscopy (SEM) images of PDMS and porosity in MWCNTs, FIG. 1D is a schematic diagram explaining the working principle of a TENG for converting mechanical energy into electrical energy through the triboelectric effect and electrostatic induction, FIG. 1E depicts the comparison of tensile force versus rate of change of length, and FIG. 1F depicts a schematic cross-section of the fabricated self-powered electroacupuncture needle;

FIGS. 2A-2D depict the SEM and optical profilometry images of porous MWCNTs@PDMS, in which FIG. 2A display SEM images of porous structure, FIG. 2B is the profilometry image representing surface morphology, FIG. 2C depicts the peaks distribution in microstructure, and FIG. 2D shows the linear dimensions of porous structure observed by SEM;

FIGS. 3A-3D depict the open circuit voltage output of different fabricated TENG, in which FIG. 3A is 2-layer TENG made with PI as electro negative and Cu as electropositive layer, FIG. 3B is PI replaced with PDMS layer as electronegative and triboelectric layer, FIG. 3C is MWCNTs@PDMS layer acts as triboelectric layer, and FIG. 3D is the summary of open circuit voltage output when 3 sensors with 3 different triboelectric materials are compared;

FIGS. 4A-4D depict the short circuit current analysis of different fabricated TENG, in which FIG. 4A is 2-layer TENG made with PI as electro negative and Cu as electropositive layer, FIG. 4B is PI replaced with PDMS layer as electronegative and triboelectric layer, FIG. 4C is MWCNTs@PDMS layer acts as triboelectric layer, and FIG. 4D is the summary of short circuit current output when 3 sensors with 3 different triboelectric materials are compared;

FIGS. 5A-5D depict the compressive and tensile stress strain relationship showing the durability and repeatability of the sensor, in which FIG. 5A shows the cyclic loading of 2-layer TENG where PDMS is the triboelectric layer, FIG. 5B demonstrates the cyclic loading of TENG sensor with MWCNTs@PDMS triboelectric layer, FIG. 5C depicts the comparison of forward and reverse compressive stress versus strain between PDMS and MWCNTs@PDMS as triboelectric layer, and FIG. 5D displays the comparative analysis of tensile stress PDMS and MWCNTs@PDMS film;

FIGS. 6A-6C depict the schematic of real-time application mimicking testing, in which FIG. 6A shows lift and thrust motion, FIG. 6B shows pinch, and FIG. 6C depicts rotation around the axis of acupuncture;

FIG. 7 depicts the open circuit voltage output of MWCNT@PDMS-Cu TENG in varied mechanical stimuli;

FIG. 8 depicts the short circuit current output of MWCNT@PDMS-Cu TENG; and

FIG. 9 depicts a self-powered electroacupuncture system according to one embodiment of the present invention.

### DETAILED DESCRIPTION

In the following description, apparatuses and/or systems of self-powered electroacupuncture and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In accordance with a first aspect of the present invention, a self-powered electroacupuncture needle is provided. It is designed to enhance the efficacy of traditional acupuncture by integrating modern triboelectric nanogenerator (TENG) technology. This needle includes a conductive needle and a TENG that works in tandem to generate electrical currents during acupuncture treatment, making it self-powered and capable of delivering electrical stimulation without the need for an external power source.

The conductive needle forms the core of the device and may be constructed from materials such as stainless steel, gold plated stainless steel, gold, silver, other conductive materials or combinations thereof. These materials are chosen for their biocompatibility and ability to conduct electrical currents efficiently during treatment. The needle's head, in one embodiment, features a coiled design that provides additional surface area for interaction with the TENG, thereby enhancing the overall electrical output.

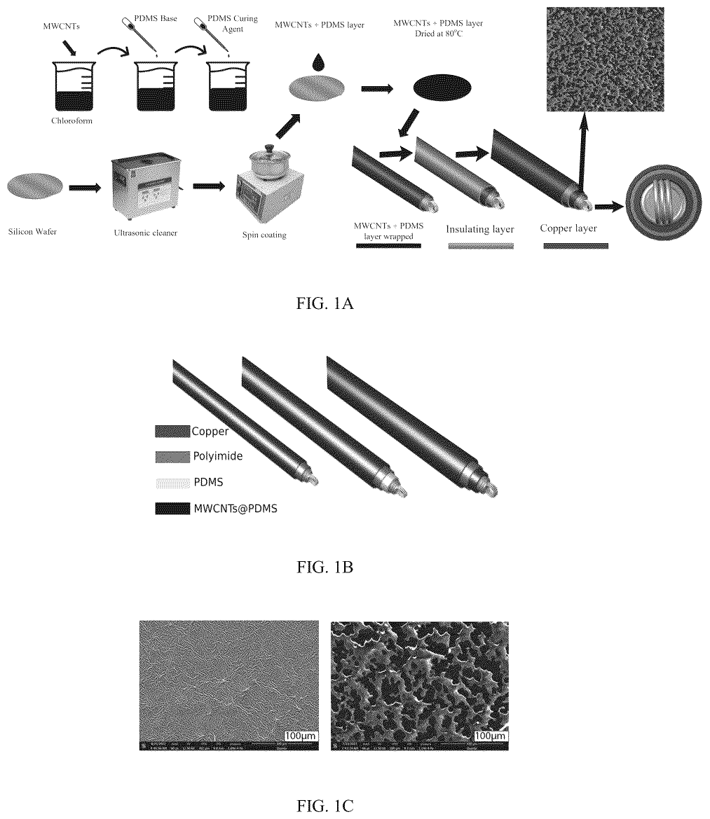

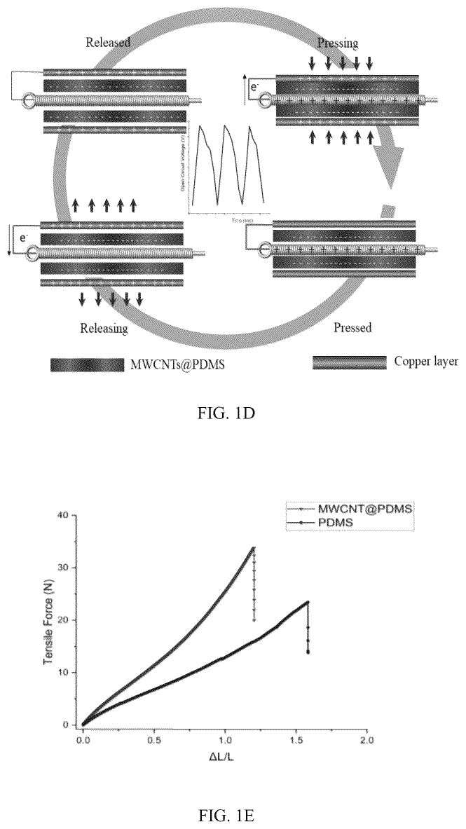

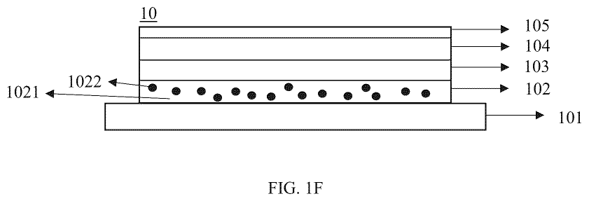

As shown in FIG. 1F, wrapped around the head of the conductive needle 101 is the TENG 10, which is composed of a triboelectric layer 102 and an electron-providing layer 104. The triboelectric layer 102 is configured to accept electrons, while the electron-providing layer is configured to donate electrons. The interaction between these layers is generates the electrical current for the electroacupuncture treatment. When the TENG is compressed by an external force—such as the pressure applied during acupuncture as the needle is inserted and withdrawn from a patient and force applied to the layers by a practitioner compressing the layers—the contact between the triboelectric layer 102 and the electron-providing layer 104 induces an electron transfer. This transfer leads to a charge separation that is facilitated by electrostatic induction, ultimately generating a current within the needle. This current enhances the therapeutic effects of acupuncture by providing localized electrical stimulation to the targeted area.

To ensure efficient and reliable operation, the TENG may further include an insulating layer 103 and a protective layer 105. The insulating layer 103 is positioned between the triboelectric layer 102 and the electron-providing layer 104 and the protective layer 105 is positioned on the electron-providing layer 104, safeguarding the components from environmental damage and ensuring long-term durability. Additionally, the triboelectric layer 102 itself is made from a flexible material 1021, such as polydimethylsiloxane (PDMS) or polyimide, doped with 1-5% of conductive nanoparticles 1022. These nanoparticles 1022, which may include multiwalled carbon nanotubes, graphene, carbon black, or silver nanowires, form a conductive mesh within the flexible material 1021, enhancing the layer's ability to generate and transfer electrical charges.

In one embodiment, the flexible material 1021 is doped with 2% of the conductive nanoparticles 1022.

In some embodiments, the triboelectric layer features a porous microstructural design with a porosity of 5-50%. This design increases the flexibility and surface area of the layer, further improving its efficiency in electron exchange during the compression and release cycles inherent in acupuncture treatments.

The electron-providing layer, which may be composed of materials such as copper (Cu), silver (Ag), gold (Au) or other suitable metals, is selected for its ability to donate electrons readily during the triboelectric process. This layer's composition is crucial to the overall functionality of the TENG, as it directly impacts the amount of current generated during treatment.

The TENG is also configured to generate an alternating current (AC) with a frequency range of 0.1-10 Hz, making it particularly suitable for electroacupuncture treatments. This frequency range is chosen to align with the therapeutic needs of patients, providing effective stimulation for pain relief, muscle relaxation, and other health benefits associated with electroacupuncture.

Overall, this self-powered electroacupuncture needle offers a significant advancement in the field of acupuncture, combining the ancient practice with cutting-edge nanogenerator technology to deliver enhanced therapeutic outcomes. The design ensures that the needle is both efficient in generating electrical currents and robust enough to withstand repeated use, making it a valuable tool for practitioners seeking to integrate modern technology into traditional healing practices.

In accordance with a second aspect of the present invention, a self-powered electroacupuncture system designed to enhance the efficacy and convenience of electroacupuncture treatments is introduced. This system incorporates multiple components that work together to deliver precise, regulated electroacupuncture therapy within a patient's body, eliminating the need for external power sources and ensuring continuous, self-sustained operation.

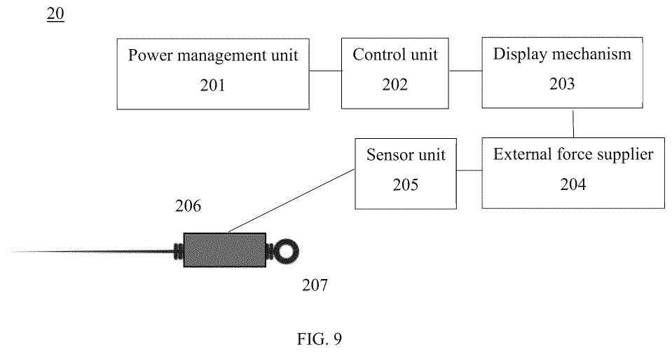

As shown in FIG. 9, a self-powered electroacupuncture system according to one embodiment of the present invention, at the core of the system 20 is at least one self-powered electroacupuncture needle, each including a conductive needle 207 and a TENG 206. The TENG 206 is ingeniously integrated with the needle 207, enabling it to generate electrical current autonomously through the process of triboelectric charging when subjected to an external force. This current is essential for conducting electroacupuncture therapy, allowing the needle 207 to stimulate targeted areas without reliance on external electrical sources.

To effectively harness and utilize the energy generated by the TENG 206, the system 20 includes a power management unit 201. This unit 201 is configured to regulate the electrical energy produced, ensuring that it is stored efficiently and made available for consistent and controlled use during treatment sessions. The power management unit 201 ensures that the system remains operational, even when the external force is intermittently applied to the TENG.

A control unit 202 is also integrated into the system 20, providing the capability to adjust the stimulation parameters of the needle. This unit 202 allows for precise control over the intensity, frequency, and duration of the electroacupuncture stimulation, tailored to the specific therapeutic needs of the patient. The control unit 202 ensures that the treatment is both effective and safe, accommodating various medical conditions and patient sensitivities.

Additionally, the system 20 is equipped with a display mechanism 203, which serves as a vital interface for the practitioner or patient to receive real-time feedback on the treatment status. This display 203 provides important information such as the current stimulation parameters, the operational status of the system 20, and other relevant data, allowing for informed adjustments and monitoring during therapy.

An essential component of the system 20 is the external force supplier 204, which is responsible for delivering the necessary mechanical force to the TENG 206. This external force triggers the triboelectric effect, enabling the TENG 206 to generate the required electrical current for electroacupuncture. The design of the external force supplier 204 is such that it can be applied in a controlled and consistent manner, ensuring the TENG 206 operates efficiently throughout the treatment process.

It is worth noting that the external force supplier 204 in the electroacupuncture system can include a manual force application, where a healthcare provider, such as a doctor, physically manipulates or pinches the needle. This manual action compresses the TENG integrated with the needle, generating the required electrical current for electroacupuncture therapy

To further enhance the system 20's capabilities, a sensor unit 205 is included to monitor various treatment parameters. This unit 205 tracks key metrics such as tissue response, temperature, and electrical conductivity, providing valuable data that can be used to optimize the treatment and ensure its effectiveness. The sensor unit 205 contributes to the overall safety and precision of the therapy, making adjustments as necessary based on the monitored data.

In some embodiments, the system also incorporates a data storage and transfer module, which is configured to record treatment data and stimulation parameters. This module allows for the preservation of detailed records of each treatment session, facilitating ongoing patient care and enabling the analysis of treatment efficacy over time. The stored data can be transferred to other devices or systems for further analysis, documentation, or sharing with healthcare providers.

Additionally, the system may include an external power source as an optional component, providing an auxiliary power supply that can be used to supplement the TENG-generated energy when necessary. This feature ensures that the system remains operational under all conditions, offering an additional layer of reliability.

For enhanced connectivity and integrated patient care, the system may be equipped with a communication interface. This interface allows the self-powered electroacupuncture system to communicate with other medical devices or a central computer system. Such connectivity enables the system to be part of a broader network of medical technologies, contributing to comprehensive patient care and facilitating coordinated treatment strategies.

Overall, the self-powered electroacupuncture system represents a significant advancement in the field of medical technology, offering a self-sufficient, precise, and reliable solution for delivering electroacupuncture therapy. Its innovative design and comprehensive features make it a versatile tool for healthcare professionals, providing improved patient outcomes and enhanced therapeutic options.

### EXAMPLES

### Example 1. Fabrications of Self-Powered Electroacupuncture Needles

The acupuncture needles used as substrates are typically made of stainless steel. In some embodiments, silver needles and gold-plated needles are also employed. All needles have a standard size of 25×0.25 mm. SYLGARD™ 184 Silicone Elastomer Kit from Sigma Aldrich, consisting of a base and a curing agent, is utilized in a 10:1 ratio of base to curing agent. The polymer is embedded with multiwalled carbon nanotubes (MWCNTs) (99.9% purity, inner diameter 5-10 nm, outer diameter 10-20 nm, and length 5-30 μm) to enhance the conductive pathways within the PDMS film, thereby creating a conductive mesh that increases power output and AC voltage generation. Chloroform is used as a solvent to facilitate the homogeneous dispersion of nanotubes. Polyimide (PI) film, known for its exceptional thermal stability and mechanical strength, provides durability and reliability and acting as an effective insulating material. The electrical insulation layer also functions as a protective layer, ensuring the integrity of the assembly (FIG. 1A).

Three distinct TENG sensor designs were prepared to evaluate the influence of conductive nanoparticles in the triboelectric layer. The first design features a 2-layer TENG comprising polyimide (PI) and copper (Cu), where PI serves as the negatively charged triboelectric layer and copper acts as both the positively charged layer and electrode. The second design also uses a 2-layer TENG, but with polydimethylsiloxane (PDMS) replacing PI. In this configuration, PDMS functions as the negatively charged triboelectric layer. The third design introduces PDMS film doped with conductive nanoparticles, which enhances the film's charge retention capabilities. In this third sensor design, the porous triboelectric MWCNTs@PDMS layer plays a crucial role in generating charge when mechanical stimuli are applied (FIG. 1B).

The PDMS matrix infused with MWCNTs functions as the triboelectric layer, leveraging the enhanced electrical conductivity and surface roughness provided by the MWCNTs to significantly improve charge generation and transfer efficiency. The porous structure of the MWCNTs@PDMS further enhances contact electrification and triboelectric effects, which amplifies the sensitivity and overall performance of the sensor. Polyimide (PI) serves as the insulating layer, chosen for its exceptional dielectric properties, high thermal stability, and mechanical flexibility, ensuring effective insulation between the triboelectric and conductive layers. This insulation is crucial in preventing electrical leakage and optimizing the sensor's efficiency and reliability. Copper, selected as the conductive layer, provides superior electrical conductivity, corrosion resistance, and mechanical durability, enabling efficient charge collection and transmission, which are essential for achieving high electrical output and stability in the sensor.

The microstructure of the MWCNTs@PDMS is fabricated by dispersing 2 wt % MWCNTs in chloroform using an ultrasonic mixer. After 30 minutes of mixing, PDMS base is added to the mixture and heated at 80° C. to reduce the base's density. Following 20 minutes of heating and magnetic stirring, the curing agent is added in a 10:1 ratio of base to curing agent. Once thoroughly mixed and with 80% of the solvent evaporated, the mixture is placed in a vacuum chamber for an hour to remove air bubbles. The mixture is then spin-coated onto a silicon wafer at 800 rpm for 120 seconds and thermally cured in an oven at 80° C. for 6 hours. The resulting film, which is 0.5 mm thick, is porous due to the presence of the solvent during the spin coating stage. Chloroform not only facilitates the uniform dispersion of nanoparticles but also plays a pivotal role in the formation of well-defined porous microstructures in the MWCNTs@PDMS film, as evidenced by scanning electron microscopy (SEM) images shown in FIG. 1C. The fabricated film provides a higher contact surface area when force is applied, ultimately generating a higher charge compared to pure PDMS. The microstructures are also analyzed using an optical profilometer, which reveal an even distribution of average peak sizes around 8 μm. Additionally, linear measurements from SEM reveal a porous structure, with pores ranging from 9 to 30 μm. This investigation provides a detailed understanding of the intricate microscale features, highlighting the variability and significance of size within this porous matrix.

The working principle of the nanogenerator can be explained by the acupuncture needle, which serves as both the substrate and the mechanical element for the TENG assembly. The coiled head of the needle provides a surface with high curvature, crucial for generating triboelectric charges through mechanical movement. The TENG comprises two active layers: Layer 1, the triboelectric MWCNTs@PDMS, which is capable of accepting electrons, and Layer 2, copper, which has a strong tendency to donate electrons. Insulating and protective layers function as a spacer and ensure the integrity of the assembly, respectively (FIG. 1B). When an external force is applied, the layers compress, inducing pressure between the PDMS and Cu layers, resulting in electron transfer based on the triboelectric series theory. The charge separation, facilitated by electrostatic induction, leads to the PDMS layer becoming negatively charged, which repels electrons towards electrode 2 (Cu), thereby generating a triboelectric charge effect. The output voltage between the electrodes is measured using an electrometer. Charge movement through the external load generates an electric current, producing AC voltage (FIG. 1D). Upon the removal of the external force, the layers return to their initial state, ceasing voltage output until mechanical energy is reapplied. The inclusion of MWCNTs in PDMS boosts voltage output by 150% compared to pure PDMS. Durability tests conducted in both compressive and tensile modes reveal performance in stretchability and compressibility that is comparable to PDMS alone (FIG. 1E).

### Example 2. Electrical Properties of Self-Powered Electroacupuncture Needles

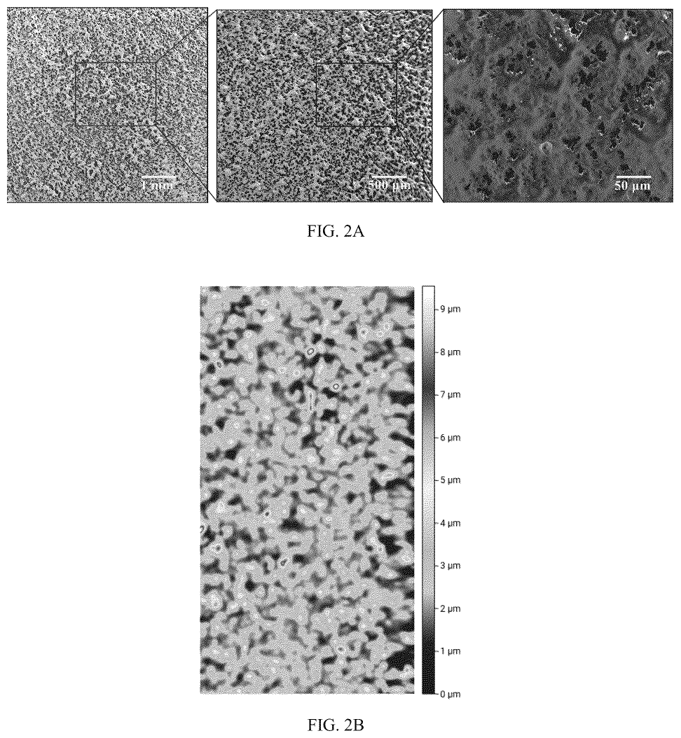

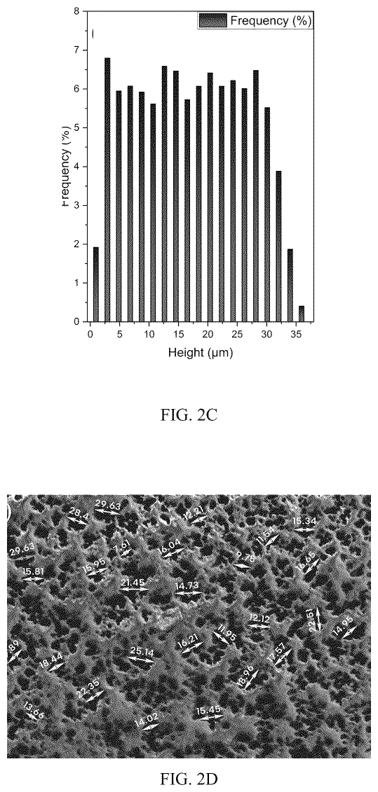

As illustrated in FIG. 1B, coiled head of acupuncture needle was in direct contact with triboelectric layer (0.5 mm). As mentioned above, three different designs are analyzed based on various triboelectric layers being PI, PDMS and MWCNTs@PDMS contributing to formation of PI-Cu, PDMS-Cu and MWCNTs@PDMS-Cu nanogenerators. The performance of these designs is assessed by considering metrics such as open-circuit voltage (V_{oc}) and short-circuit current (I_{sc}). The results indicate that MWCNTs@PDMS shows the most stable output with highest sensitivity compared to the other two designs due to presence of porous microstructure (FIG. 2A). After conducting comprehensive experiments, it is verified that the porous microstructure of the MWCNTs@PDMS film remain intact and exhibited a stable voltage output. Furthermore, the selection of the substrate material has a substantial impact on the output of the TENG. Moreover, three distinct types of acupuncture needles are utilized, specifically made of stainless steel (SS), gold-plated (GP), and silver (Ag) needles. Their performance is observed to be directly related to the conductivity of substrate material, silver needle being the best of all. The electrical properties measurement involves using 2-electrode measurement by establishing a connection between copper, the outermost layer of TENG sensor and the substrate needle shaft. The copper layer serves a dual purpose, functioning as both an electron donor and an electrode. Moreover, linear measurements are also observed by SEM that show porous structure, unveiling a spectrum of linear measurements spanning from 9 to 30 μm. This investigation provides a nuanced understanding of the intricate microscale features, shedding light on the variability and significance of size within this porous matrix.

From SEM analysis microstructure with average width of 25 μm in width and 8 μm in height. The solvent evaporation at drying stage of the film provides the porous structure which in turn increases the contact area when force is applied (FIG. 2A). From the profilometer images, the peaks distribution observed aligned with results from SEM (FIG. 2B and FIG. 2C). Due to the microporous structure formed in triboelectric film of the sensor the polarized molecules were directly proportional to the conductive nanoparticles.

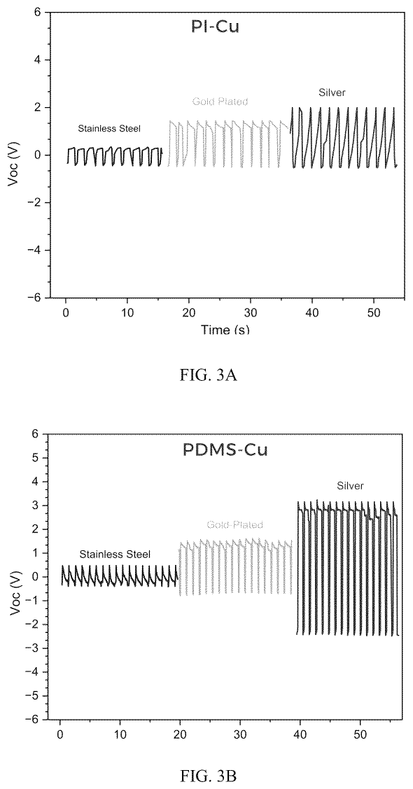

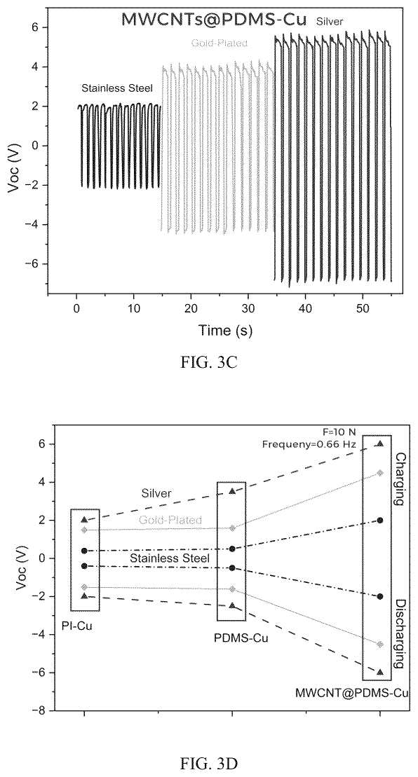

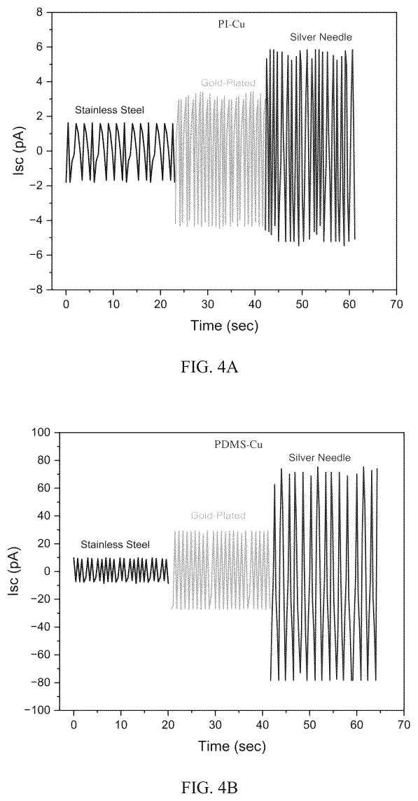

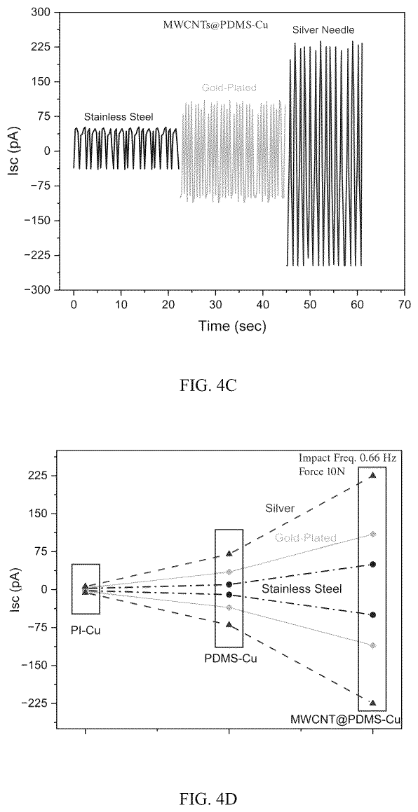

To understand the influence of conductive nanoparticles in triboelectric layer, the output open-circuit voltage (V_{oc}) and short-circuit current (I_{sc}) are compared. According to the theory of electrostatic induction, the farther the materials on triboelectric series are, the more charges are generated when come into contact. The charge generation in case of our experiments are dependent on the triboelectric layer of sensor as well as the substrate. When the triboelectric layer is PI and the substrate needle is SS, V_{oc} and I_{sc} range between ±0.5 volts and ±2 pA. In the same design of sensor when substrate is replaced with GP and Ag needles, V_{oc} and I_{sc} range between ±1.8, ±2 volts and ±5, ±6 pA. This type of sensor has diameter of 2.4 mm and is tested under constant testing conditions of 10 N force and 0.66 Hz frequency (FIG. 3A and FIG. 4A).

According to triboelectric theory, the electron affinity of PDMS is higher than PI, it has the ability to generate more charge. When PI is replaced with transparent PDMS film, the charge generation ability of the sensor is proved to be higher and generates 4 times more V_{oc} as compared to PI-Cu TENG. The V_{oc} and I_{sc} of PDMS-Cu is ±0.8, ±2, ±3.5 and ±10, ±30, ±80 pA for SS, GP and Ag respectively (FIG. 3B and FIG. 4B).

To enhance the efficiency of the TENG sensor, the triboelectric layer is modified by incorporating MWCNTs to create conductive pathways (FIG. 2D). When pressure is applied to the sensor, these conductive nanoparticles form an interconnected network, which significantly improves the sensor's sensitivity. Additionally, the porous microstructures, formed due to the solvent during the drying stage of the triboelectric film, provide a larger contact surface area when subjected to mechanical stimuli (FIG. 3C and FIG. 4C). V_{oc} and I_{sc} for the porous MWCNTs@PDMS film as the triboelectric layer, shown in FIG. 3C and FIG. 4C, are ±2, ±4, and ±6 volts, and ±50, ±110, and ±225 pA, respectively, when the substrates are SS, GP, and Ag needles. Table 1 compares the V_{oc} and I_{sc} values across all three sensor types. The sensors have been tested for over 1,000 cycles of both cyclic loading and linear motor tests, with no observed fatigue. The enhancements in sensor output are attributed to the presence of nanotubes and the increased porosity of the film, which significantly improve the performance of the triboelectric layer.

FIG. 3D and FIG. 4D describes the comparison analysis of three different designs of 2-layer TENG showing the improvement of output while maintaining the flexibility and sensitivity of the sensors. The design has been proven to be the most suitable for small power generation capable enough to make small devices self-powered.

Examining the fold increase in V_{oc} and I_{sc} values reveals interesting insights. When comparing different substrates with the reference material of PI-Cu on SS, significant improvements are observed. Using GP as the substrate with PI-Cu material leads to a 3.6-fold increase in V_{oc} and a 2.5-fold increase in I_{sc}. Similarly, employing Ag as the substrate with PI-Cu material results in a 4-fold increase in V_{oc} and a 3-fold increase in I_{sc}.

Furthermore, the introduction of PDMS-Cu as a material on SS substrate yields a 1.6-fold increase in V_{oc} and an impressive 5-fold increase in I_{sc}. This demonstrates the influence of both the material and substrate on the TENG device's performance. Additionally, the incorporation of MWCNTs@PDMS-Cu on GP substrate exhibits a 2-fold increase in I_{sc} compared to the reference material. These findings highlight the importance of material and substrate selection in optimizing TENG device performance. The choice of materials and substrates can significantly impact the generated voltage and current, thereby enhancing the overall efficiency and effectiveness of energy harvesting.

TABLE 1
Comparison of TENG material, substrate, V_{oc}, I_{sc}, and fold increase
in V_{oc} and I_{sc} when the substrate and the TENG materials change

| | | | | Fold | Fold |
|---|---|---|---|---|---|
| | | V_{oc} | I_{sc} | Increase | Increase |
| TENG Material | Substrate | (volts) | (pA) | (V_{oc}) | (I_{sc}) |
| PI-Cu | SS | ±0.5 | ±2 | — | — |
| PI-Cu | GP | ±1.8 | ±5 | 3.6 | 2.5 |
| PI-Cu | Ag | ±2 | ±6 | 4 | 3 |
| PDMS-Cu | SS | ±0.8 | ±10 | 1.6 | 5 |
| PDMS-Cu | GP | ±2 | ±30 | 2.5 | 3 |
| PDMS-Cu | Ag | ±3.5 | ±80 | 4.4 | 4 |
| MWCNTs@PDMS-Cu | SS | ±2 | ±50 | 2.5 | 5 |
| MWCNTs@PDMS-Cu | GP | ±4 | ±110 | 2 | 2.2 |
| MWCNTs@PDMS-Cu | Ag | ±6 | ±225 | 3 | 2.04 |

The observed fold increases in V_{oc} and I_{sc} values across different TENG materials and substrates can be logically explained by considering the influence of material properties and substrate characteristics on the triboelectric effect and electrical performance. In terms of material properties, PI-Cu vs. PDMS-Cu: The switch from PI to PDMS as the triboelectric layer introduces a different material with varying triboelectric properties. PDMS tends to generate higher triboelectric charges, leading to a 1.6-fold increase in V_{oc} and an impressive 5-fold increase in I_{sc} on SS substrate. This is attributed to the enhanced charge separation capabilities of PDMS. The addition of MWCNTs to PDMS introduces porosity, enhancing the triboelectric effect. This results in a 2-fold increase in I_{sc} compared to the reference material (PDMS-Cu) on SS substrate, showcasing the positive impact of incorporating MWCNTs on current output. In terms of change in substrate: The choice of substrate also significantly influences TENG performance. GP and Ag substrates exhibit higher conductivity and work function than SS, contributing to improved charge transfer and a consequent increase in both V_{oc} and I_{sc}. This explains the observed 3.6 to 4-fold increase in V_{oc} and 2.5 to 3-fold increase in I_{sc} when transitioning from SS to GP or Ag substrates.

When material substrate differences come together, the combination of specific TENG materials with compatible substrates contributes to synergistic effects. For instance, PDMS-Cu on GP substrate yields a 2.5-fold increase in V_{oc} and 3-fold increase in I_{sc}, showcasing the importance of optimizing material-substrate combinations for enhanced performance. In summary, the observed fold increases are attributed to the inherent triboelectric properties of the materials, the porosity introduced by MWCNTs, and the conductivity and work function of different substrates. This logical analysis underscores the significance of thoughtful material and substrate selection for optimizing TENG device performance in energy harvesting applications.

The cyclic loading testing is also conducted. Sensors with a diameter of 4 mm were tested during this experiment. The instrument is configured to operate in compressive mode and underwent calibration procedures to provide precise and consistent outcomes. The compressive stress of 25 MPa is employed as the controlling parameter for the analysis of the stress-strain relationship. Each sample is carefully placed in the clamps, and an initial force is exerted at rate of 2 mm per minute until the stress reaches a magnitude of 25 MPa. The initial strain and load values are documented. Following this, cyclic loading is commenced using a sinusoidal load, aiming to achieve a maximum strain of 35%. The load cell employed for the cyclic loading has a capacity of 500 N. The mechanical durability of the sensors is observed during a thorough testing process consisting of 1,000 cycles. The load and strain data are consistently monitored and documented throughout the duration of the experiment. Subsequently, the gathered data is subjected to analysis in order to assess the cyclic durability of the material, based on the stress vs. strain curves.

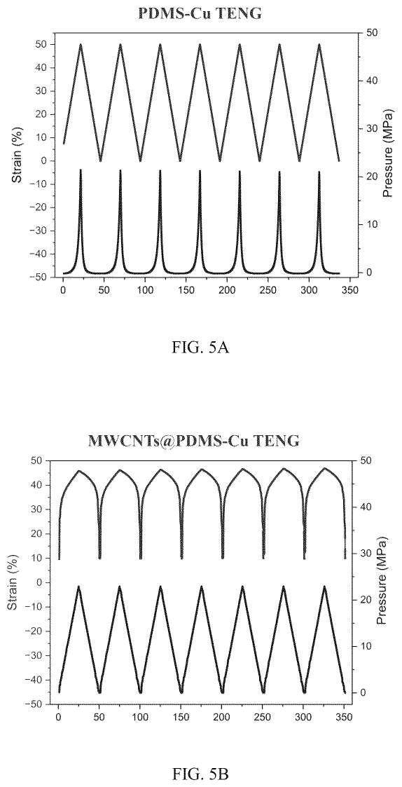

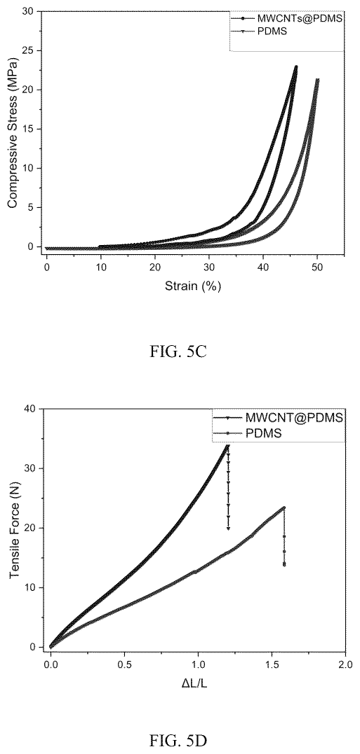

To understand the mechanical durability, the relationship between compressive stress and strain at rate of 2 mm per minute are plotted shown in FIGS. 5A-5D. The response of applied force on the sensors containing PDMS and MWCNTs@PDMS are compared to observe the influence of microporous structure in the proposed sensor design. As shown in FIG. 5B, PDMS-Cu TENG sensor shows the clear trend of cyclic relationship with applied force (450 N). The difference in response of PDMS-Cu sensor and MWCNTs@PDMS-Cu sensor clearly shows the increased sensitivity with applied force. This trend is accredited to the microporous structure of the triboelectric layer as well as the infusion of nanotubes that works with strengthening the film and making it more resistive to strain. The sensor endures 23 MPa of pressure and shows 46% strain while PDMS-Cu shows 50% strain under 20 MPa of pressure. FIG. 5C and FIG. 5D demonstrate the stress-strain relationship between PDMS-Cu TENG and MWCNTs@PDMS TENG. The MWCNTs@PDMS TENG shows stable output while going through cyclic loading and showing repeatability for 1000 cycles. The conductive network goes through disrupted/connected during loading/unloading cycles representing flexibility as well as repeatability suitable for healthcare applications.

### Example 3. Real-Time Application Mimicking Testing: A Rigorous Evaluation of TENG Sensor Performance

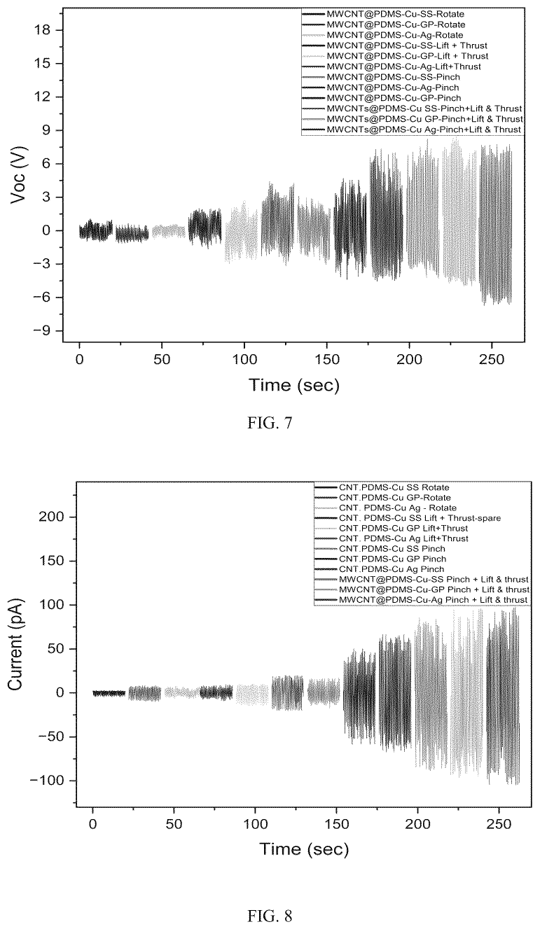

In pursuit of a comprehensive assessment of the viability and adaptability of our TENG sensor designs, a series of real-time application tests are meticulously conducted. These tests are specifically designed to mimic the motion of acupuncture needle to scrutinize the sensors' responsiveness to varying mechanical stimuli and, consequently, to elucidate their potential for deployment in dynamic and unpredictable environments, where reliability and versatility are paramount. While the primary application of these sensors lies in human tissue during acupuncture treatments, the decision to employ polyethylene foam materials for testing is strategic. It allows for systematic and controlled evaluation, eliminating confounding variables and enhancing the precision of the results. In the initial mechanical testing, a force of 10N is applied to assess the sensor's performance under controlled conditions. Real-time application tests are performed to mimic real-world scenarios involving lift-thrust, pinch, and rotate movements. These movements simulate the forces encountered during acupuncture practice and provide practical insights into the sensor's performance for actual application. This approach is particularly valuable in the early stages of sensor development and optimization (FIG. 7 and FIG. 8).

### Lift and Thrust Motion:

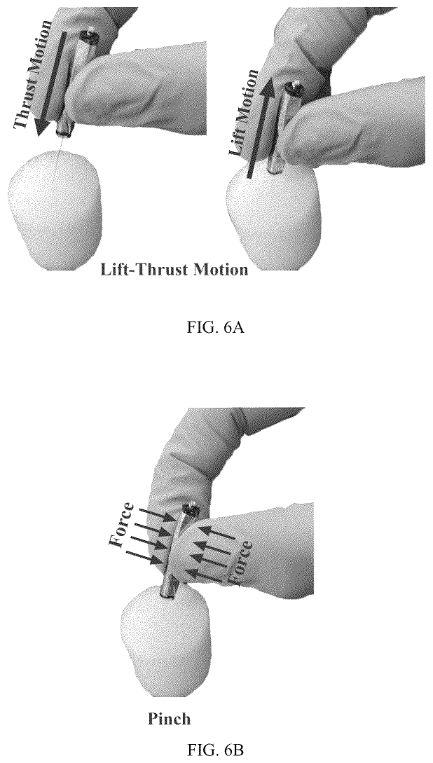

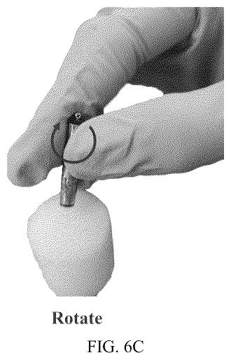

As shown in FIG. 6A, the inaugural test aims to emulate scenarios characterized by vertical movement or force exertion. Herein, a controlled lift-and-thrust motion is executed, with a displacement amplitude of precisely 10 mm. The underlying objective is to gauge the TENG sensor's capacity to swiftly capture and translate abrupt alterations in mechanical energy into discernible electrical output.

### Rotation Around the Axis of Acupuncture:

As shown in FIG. 6B, the secondary test scenario is meticulously devised to probe the TENG sensor's interaction with rotational forces. This test involves controlled rotational motion of acupuncture needle around the axis of acupuncture. It is crafted to mirror situations where rotational motion is provided by the physician during the procedure.

### Pinch:

As shown in FIG. 6C, another scenario involves subjecting the TENG sensors to a pinching motion, a dynamic and rapid mechanical stimulus. The sensors, with their high sensitivity and responsiveness, effectively harness the abrupt mechanical energy produced during the pinching process.

In conclusion, the MWCNTs@PDMS-Cu TENG configuration exemplifies a synergistic fusion of traditional therapeutic practices and cutting-edge energy harvesting technologies. It is the most suitable choice for enhancing the efficacy of electroacupuncture procedures due to its exceptional stability, sensitivity, and durability. The MWCNTs@PDMS-Cu TENG design illuminates a transformative path toward more effective, patient-centred therapeutic interventions. The MWCNTs@PDMS-Cu TENG exhibits exceptional stability, sensitivity, and endurance, rendering it a promising candidate for transformative advancements in healthcare. The applications of this technology span a wide spectrum, encompassing wearable devices that utilize it to supply power to sensors and monitor vital signs, as well as self-powered sensors that facilitate the collection of real-time data without relying on external sources of power. Incorporating our TENG into electroacupuncture treatments, including analgesic effect, gastrointestinal disorders, cerebrovascular accidents, anxiety, and depression, promises to expedite wound healing, optimize pain control, and augment rehabilitation outcomes within biomedical applications.

The microstructure of the MWCNTs@PDMS-based TENG exhibit a remarkable capacity to maximize the triboelectric effect, resulting in the most stable open-circuit voltage and short-circuit current. This, coupled with the design's mechanical durability, made it the best option for electroacupuncture therapy applications. The stability, sensitivity, and durability of the MWCNTs@PDMS-Cu TENG design have been rigorously evaluated, and the results validate its potential as a self-powered energy source for electroacupuncture procedures. This robustness is of the utmost importance because it ensures consistent and long-lasting energy delivery in therapeutic settings.

The real-time mechanical stimuli testing of these TENG sensors on acupuncture needles underscores their exceptional responsiveness and adaptability to a wide spectrum of mechanical movements. These sensors have proven their capability to efficiently harvest energy during acupuncture procedures, including lift and thrust, rotation, and flicking motions. This adaptability positions them as valuable tools for electroacupuncture therapy, where the sensors can simultaneously provide therapeutic benefits and self-sustaining energy. These results open up innovative possibilities for interdisciplinary applications of traditional practices and modern energy harvesting technology.

The garnered data represents the sensor's adaptability in scenarios necessitating an agile response to twisting and turning motions. This capability emphasizes the adaptability of these sensors to a broad range of mechanical stimuli. The testing is conducted using real-time movement data, ensuring that the sensors are subjected to random forces and frequencies. This approach simulates real-life scenarios where the mechanical stimuli encounter during acupuncture treatments may vary in both force and frequency. The TENG sensors excel in capturing and converting these diverse mechanical energies into electrical power.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A self-powered electroacupuncture needle, comprising:
a conductive needle; and
a triboelectric nanogenerator (TENG) coating on at least a portion of the conductive needle, comprising:
a triboelectric layer configured to accept electrons; and
an electron-providing layer configured to donate electrons;
wherein the TENG is positioned on the conductive needle with the triboelectric layer in contact with the needle such that electron transfer is induced between the triboelectric layer and the electron-providing layer when these layers are compressed, generating a therapeutic alternating current at a frequency range of 0.1-10 Hz in the needle for delivering electroacupuncture treatment.

2. The self-powered electroacupuncture needle of claim 1, wherein a head of the conductive needle is a coiled head.

3. The self-powered electroacupuncture needle of claim 1, wherein the TENG further comprises an insulating layer and a protective layer.

4. The self-powered electroacupuncture needle of claim 3, wherein the insulating layer is positioned between the triboelectric layer and the electron-providing layer and the protective layer is positioned on the electron-providing layer.

5. The self-powered electroacupuncture needle of claim 1, wherein the triboelectric layer is a flexible material doped with 1-5% of conductive nanoparticles, wherein the conductive nanoparticles form a conductive mesh within the flexible material.

6. The self-powered electroacupuncture needle of claim 5, wherein the flexible material is selected from polydimethylsiloxane or polyimide.

7. The self-powered electroacupuncture needle of claim 5, wherein the conductive nanoparticles are selected from multiwalled carbon nanotubes, graphene, silver nanowires, or carbon black.

8. The self-powered electroacupuncture needle of claim 5, wherein the triboelectric layer has a porous microstructure with a porosity ranging from 5-50%, configured for increasing the surface area for electron exchange.

9. The self-powered electroacupuncture needle of claim 5, wherein the flexible material is doped with 2% of the conductive nanoparticles.

10. The self-powered electroacupuncture needle of claim 1, wherein the electron-providing layer is composed of a conductive metal selected from one or more of Cu, Ag, or Au.

11. The self-powered electroacupuncture needle of claim 1, wherein the conduct needle comprises a material selected from stainless-steel, gold plaited stainless steel, gold, silver, or a combination thereof.

12. A self-powered electroacupuncture system, comprising:
One or more of the self-powered electroacupuncture needles of claim 1, comprising a conductive needle and a TENG, configured to generate a current for conducting electroacupuncture;
a power management unit configured to regulate and store electrical energy generated by the TENG;
a control unit configured to adjust stimulation parameters of the needle;
a display mechanism for providing feedback on treatment status;
an external force supplier configured to supply an external force to the TENG; and
a sensor unit for monitoring treatment parameters.

13. The self-powered electroacupuncture system of claim 12, further comprising a data storage and transfer module configured to record treatment data and the stimulation parameters.

14. The self-powered electroacupuncture system of claim 12, further comprising an external power source.

15. The self-powered electroacupuncture system of claim 12, further comprising a communication interface configured to allow the system to communicate with other medical devices or a central computer system for integrated patient care.

16. The self-powered electroacupuncture system of claim 12, wherein the external force supplier comprises a manual force applied by a healthcare provider, wherein the manual force, comprising but not limited to pinching, rotating, lifting-and-thrusting, or pressing the needle, compresses the TENG to generate the electrical current necessary for electroacupuncture treatment.
